(19) United States
(12) Patent Application Publication
(10) Pub. No.: US 2011/0254341 A1
(43) Pub. Date: Oct. 20, 2011

(54) MODULAR MASSAGE CHAIR

(76) Inventor: David POTTER, Los Angeles, CA (US)

(21) Appl. No.: 13/084,362

(22) Filed: Apr. 11, 2011

Related U.S. Application Data
(60) Provisional application No. 61/342,515, filed on Apr. 14, 2010.

(51) Int. Cl. A47C 7/00; B23P 11/00

(52) U.S. Cl. 297/440.1; 29/428; 29/525.08

(57) ABSTRACT

A modular massage chair including a core module including a core module seat portion and a core module backrest portion; and at least one modular outer chair portion attachable to at least one side of the core module. The at least one modular outer chair portion may include a first outer seat portion attachable to the core module seat portion at a first side of the core module; a second outer seat portion attachable to the core module seat portion at a second side of the core module opposite the first side; a first outer backrest portion attachable to the core module backrest portion at the first side of the core module; and a second outer backrest portion attachable to the core module backrest portion at the second side of the core module.

### CROSS-REFERENCE TO RELATED APPLICATION

This application claims priority to and the benefit of U.S. Provisional Patent Application No. 61/342,515, filed on Apr. 14, 2010 in the United States Patent and Trademark Office, the entire content of which is incorporated herein by reference.

### FIELD

Aspects of embodiments of the present invention relate to a massage chair, and more particularly, to a modular massage chair.

### BACKGROUND

Massage chairs are commonly used for providing a massage to the back and/or legs of a user while the user is seated. Typically, massage chairs are fabricated and assembled at a place of manufacture and transported to a retailer or user as an assembled unit. As such, typical massage chairs are bulky and costly to transport and store. Additionally, massage chairs are typically offered by a manufacturer in only a few limited styles. Further, the different offered styles typically do not include a portion that is common or interchangeable to each of them, resulting in high design and tooling costs.

As such, there is a need to provide a massage chair that is easily transported or stored. Further, there is a need for a massage chair that is configured to be provided in a number of various styles. Additionally, there is a need to provide a massage chair having a standardized portion for use in various massage chairs.

### SUMMARY

According to an aspect of embodiments of the present invention, a modular massage chair includes a core portion and attachable pod portions that are storable and transportable separately from one another for ease of storage and transporting. According to another aspect of embodiments of the present invention, a method of assembling a modular massage chair having attachable pod portions is provided.

According to another aspect of embodiments of the present invention, a modular massage chair includes a standardized core portion for use in assembling massage chairs having style pods of various available style pods that are attachable to the core portion for customizing a massage chair as desired by a specific user. Further, the standardized core portion of massage chairs according to an embodiment of the present invention reduces costs of fabrication, tooling, storage, and transporting.

According to one embodiment of the present invention, a modular massage chair includes: a core module including a seat portion and a backrest portion; and a plurality of style pods including a first seat pod attachable to a first side of the seat portion, a second seat pod attachable to a second side of the seat portion, a first backrest pod attachable to a first side of the backrest portion, and a second backrest pod attachable to a second side of the backrest portion. The core module may include sockets configured to receive connectors, and the style pods may also include connectors, the connectors of each of the core module and the style pods configured to receive a pin therein for attaching the style pods to the core module.

According to another embodiment of the present invention, a modular massage chair includes a core module including a core module seat portion and a core module backrest portion; and at least one modular outer chair portion attachable to at least one side of the core module.

In one embodiment, the at least one modular outer chair portion includes: a first outer seat portion attachable to the core module seat portion at a first side of the core module; a second outer seat portion attachable to the core module seat portion at a second side of the core module opposite the first side; a first outer backrest portion attachable to the core module backrest portion at the first side of the core module; and a second outer backrest portion attachable to the core module backrest portion at the second side of the core module.

In one embodiment, the core module further includes a plurality of first socket-type connectors, and the at least one modular outer chair portion includes a plurality of second socket-type connectors, and the modular massage chair further includes a plurality of pins, each of the pins being insertable into a first connector of the plurality of first connectors and a second connector of the plurality of second connectors for attaching the at least one modular outer chair portion to the at least one side of the core module. The modular massage chair may further include a locking device configured to lock the pin and the first and second connectors together. At least one of the first and second connectors may include a spiked end configured to pierce a cover material of at least one of the core module or the at least one modular outer chair portion.

In one embodiment, the modular massage chair further includes a hook-and-loop type fastener affixed to the core module and the at least one modular outer chair portion for attaching the at least one modular outer chair portion to the at least one side of the core module.

At least one of a material or a color of the at least one modular outer chair portion may be different from a respective material or color of the core module.

In one embodiment, the core module has a standardized configuration such that the at least one modular outer chair portion is interchangeable with at least one other modular outer chair portion. The core module may have a width of about 16 inches to about 18 inches.

According to another embodiment of the present invention, a modular massage chair system includes: a core module including a seat portion and a backrest portion; and a plurality of modular chair portions attachable to at least one side of the core module, and modular chair portions of the plurality of modular chair portions are interchangeably attachable to the at least one side of the core module.

In one embodiment, at least one of a shape, a size, or a color of a modular chair portion of the interchangeably attachable modular chair portions is different from a respective shape, size, or color of another of the interchangeably attachable modular chair portions.

The core module may further include a plurality of first connectors, and the modular chair portions comprise a plurality of second connectors engageable with the first connectors for attaching the modular chair portions to the at least one side of the core module. In one embodiment, the core module has a pattern of locations of the first connectors, and locations of second connectors of the plurality of second connectors of each of the interchangeably attachable modular chair portions correspond to locations of first connectors of the pattern of locations of the core module.

According to another embodiment of the present invention, a method of assembling a modular massage chair includes providing a core module including a core module seat portion and a core module backrest portion, and attaching at least one modular outer chair portion to the core module.

In one embodiment, attaching the at least one modular outer chair portion to the core module includes attaching a first outer seat portion of the at least one modular outer chair portion to the core module seat portion at a first side of the core module; attaching a second outer seat portion of the at least one modular outer chair portion to the core module seat portion at a second side of the core module opposite the first side; attaching a first outer backrest portion of the at least one modular outer chair portion to the core module backrest portion at the first side of the core module; and attaching a second outer backrest portion of the at least one modular outer chair portion to the core module backrest portion at the second side of the core module.

Attaching the at least one modular outer chair portion to the core module may include inserting a pin into a socket-type connector of each of the core module and the at least one modular outer chair portion. In one embodiment, attaching the at least one modular outer chair portion to the core module includes attaching a loop portion of a hook-and-loop type fastener that is affixed to at least one of the core module and the at least one modular outer chair portion to a hook portion of the hook-and-loop type fastener that is affixed to at least the other of the core module and the at least one modular outer chair portion.

The method of assembling a modular massage chair may further include interchanging the at least one modular outer chair portion with at least one other modular outer chair portion.

Additional aspects and/or advantages of embodiments of the present invention are set forth in the following description and accompanying drawings, or may be obvious in view thereof to those skilled in the art.

### BRIEF DESCRIPTION OF THE DRAWINGS

The above and other features and advantages will become more apparent to those of ordinary skill in the art by describing in detail some exemplary embodiments of the present invention with reference to the attached drawings, in which:

FIG. 1 is a perspective view of a modular massage chair according to an embodiment of the present invention;

FIG. 2 is an exploded perspective view of the modular massage chair of FIG. 1;

FIG. 3 is a schematic perspective view of an inner structure of the modular massage chair of FIG. 1;

FIG. 4 is a perspective view of a modular massage chair according to another embodiment of the present invention;

FIG. 5 is a perspective view of a modular massage chair according to another embodiment of the present invention;

FIG. 6 is a perspective view of a modular massage chair according to another embodiment of the present invention; and

FIG. 7 is a flowchart showing tasks of a method of assembling a modular massage chair according to an embodiment of the present invention.

### DETAILED DESCRIPTION

Some exemplary embodiments will now be described more fully hereinafter with reference to the accompanying drawings; however, embodiments of the present invention may be embodied in different forms and should not be construed as limited to the exemplary embodiments illustrated and set forth herein. Rather, these exemplary embodiments are provided by way of example for understanding of the invention and to convey the scope of the invention to those skilled in the art.

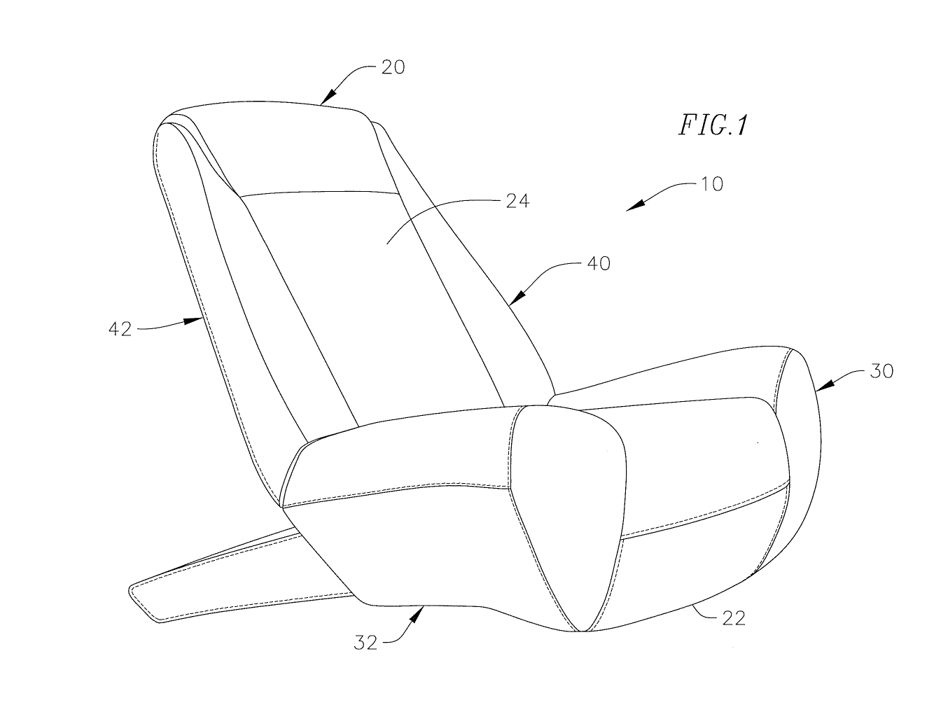

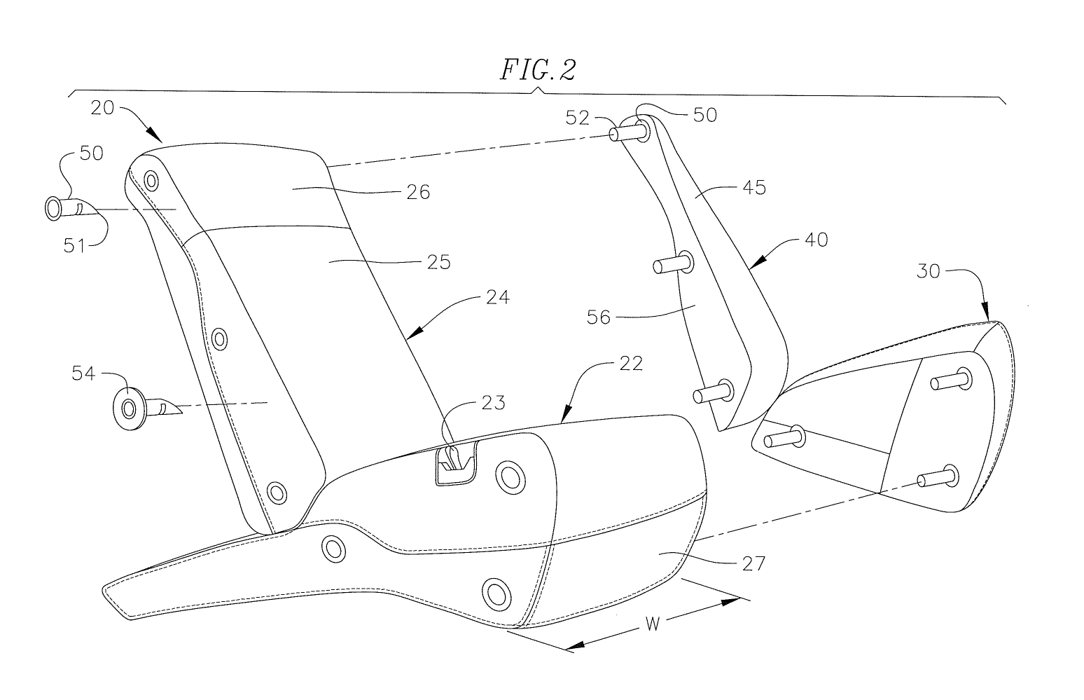

With reference to FIGS. 1 and 2, a modular massage chair 10 according to one embodiment of the present invention includes a core module 20 and one or more pods, or “style pods,” that are attachable to the core module 20.

In one embodiment, the core module 20 includes a seat portion 22 and a backrest portion 24. The seat portion 22 and the backrest portion 24 may be joined to each other by any suitable device or method known in the art. In one embodiment, the core module 20 may include an adjustment device 23 configured to adjust the seat portion 22 relative to the backrest portion 24. Similarly, in one embodiment, the backrest portion 24 may be reclinable relative to the seat portion 22 via the adjustment device 23 or another device or mechanism. In one embodiment, the core module 20 further includes one or more massaging devices (not shown), which may be located in the seat portion 22 and/or the backrest portion 24. The core module 20 may further include control and power management devices and/or a heating device. The core module 20 may have a standardized width W (see FIG. 2), such as a width selected for ease of storing, such as at a warehouse or a retail display site, and/or for ease of transporting the core module 20. In one embodiment, the width W is 16 inches to 18 inches. For example, the width W may be suitable for packaging and shipping the core module 20 as a single universal module.

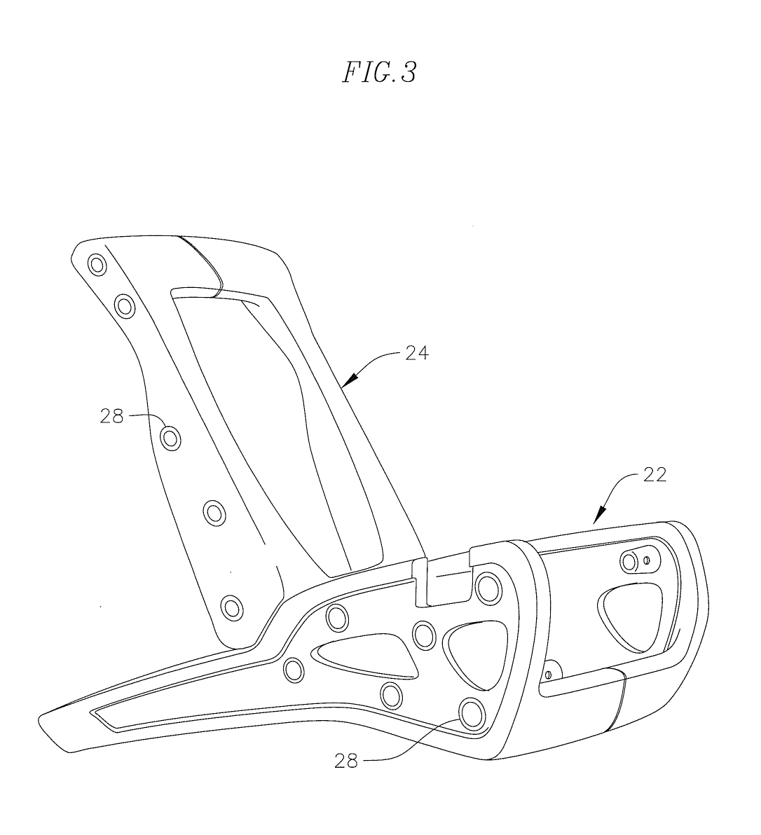

The core module 20, in one embodiment, includes an internal structure (described further below in connection with FIG. 3) and a cover over the internal structure. In one embodiment, the cover includes a first cover portion 25 formed of SOFSUEDE, a second cover portion 26 formed of stretch nylon, and a third cover portion 27 formed of polyurethane (PU). SOFSUEDE is a registered trademark of Human Touch, LLC, Long Beach, Calif. However, the present invention is not limited thereto and, in other embodiments, the cover may be fabricated from any other suitable material or combination of materials, such as exclusively from SOFSUEDE. Also, in one embodiment, the cover of the core module 20 is black for providing contrast with the style pods having a lighter color. However, the present invention is not limited thereto and, in other embodiments, the core module 20 may be light in color and the style pods may be dark in color, or the core module 20 and the style pods may have the same or a similar color or any other desired combination of colors.

In one embodiment, as shown in FIG. 1, the modular massage chair 10 includes a left seat pod 30 that is attachable to a left side of the seat portion 22, a right seat pod 32 that is attachable to a right side of the seat portion 22, a left backrest pod 40 that is attachable to a left side of the backrest portion 24, and a right backrest pod 42 that is attachable to a right side of the backrest portion 24. The pods 30, 32, 40, 42 are attachable to the core module 20 to give the modular massage chair 10 its overall usable form (i.e. its shape and size). The pods 30, 32, 40, 42 may have a cover fabricated from any suitable material, such as PU, or a combination of materials, and may have any desired color, such as a light color contrasting with a black or dark color of the core module 20. Also, the pods 30, 32, 40, 42 may have an inner structure of foam, plastic, or any other suitable material, formed by molding, for example. The inner structure of the pods 30, 32, 40, 42 may be similar to that of the core module 20, as described below in connection with FIG. 3.

In one embodiment, the pods 30, 32, 40, 42 are attachable to the core module 20 by inserting pins 52 into socket-type connectors 50 of each of the core module 20 and the pods 30, 32, 40, 42. The pods 32 and 42 are not shown in FIG. 2 for clarity of illustration of the connectors 50. In one embodiment, the connectors 50 and/or the pins 52 may include indexing holes or another suitable device for alignment. Further, in one embodiment, the connectors 50 and/or the pins 52 include a locking device, such as snap retaining hardware to lock the pods 30, 32, 40, 42 in place on the core module 20. The locking device, in one embodiment, produces an audible “pop” or “click” such that a user assembling the modular massage chair 10 is ensured that the attachment is made. Further, in one embodiment, the connectors 50 and/or the cover of the core module 20 may include hook portions 54 of a hook-and-loop fastener and the connectors 50 and/or the covers of the pods 30, 32, 40, 42 may include loop portions 56 of the hook-and-loop fastener. Alternatively, the connectors 50 and/or the cover of the core module 20 may include loop portions of a hook-and-loop fastener and the connectors 50 and/or the covers of the pods 30, 32, 40, 42 may include hook portions of the hook-and-loop fastener. Such hook-and-loop fasteners may be used instead of, or in addition to, the locking device of the connectors 50 and/or the pins 52 described above.

With reference to FIG. 3, the core module 20 is shown without the cover in order to more clearly illustrate the inner structure of the core module 20. As shown in FIG. 3, the core module 20, in one embodiment, includes the seat portion 22 and the backrest portion 24, formed of a plastic or foam material by molding, for example. Further, in one embodiment, the inner structure of the core module 20 includes sheet metal, welded tubing, and/or wire construction. In one embodiment, as depicted in FIG. 3, the core module 20 may be molded in substantially symmetric halves or, in other embodiments, may be molded or otherwise fabricated in any other suitable number of portions. The seat portion 22 and the backrest portion 24 include a plurality of sockets 28 arranged (e.g., by molding or welding) in the seat portion 22 and the backrest portion 24 in an array of suitable locations corresponding to the locations of the connectors 50. The sockets 28 are configured to receive the connectors 50, which are insertable into the sockets 28, such as by driving the connectors 50 through the cover of the core module 20. In one embodiment, the connectors 50 may have a spiked portion 51 at an end thereof for driving the connectors 50 through the cover of the core module 20 and into the sockets 28. The pods 30, 32, 40, 42, in one embodiment, may have a similar construction as the core module 20 including the sockets 28 incorporated (e.g., by molding or welding) into an inner structure of each of the pods 30, 32, 40, 42. In one embodiment, the sockets 28 of the core module 20 may be located at positions corresponding to the connectors 50 of all of the various style pods intended to be used in conjunction with the core module 20. Further, at least one connector location of one style pod may coincide with at least one connector location of another style pod.

In one embodiment, the connectors 50 include a locking device for locking the pins 52 in place in the connectors 50, such that once the pods 30, 32, 40, 42 are attached to the core module 20, they are not detachable. However, the present invention is not limited thereto and, in other embodiments, the connectors 50 and the pins 52 may be configured such that the pods 30, 32, 40, 42 are removably attachable to the core module 20 and interchangeable with other pods. Additionally, while in one embodiment the pods 30, 32, 40, 42 are attachable to the core module 20 via the sockets 28, the connectors 50, and the pins 52, the present invention is not limited thereto and, in other embodiments, the pods 30, 32, 40, 42 may be attachable to the core module 20 using snaps, fasteners, magnets, hook-and-loop fasteners, or any other suitable device or method or combination thereof. Further, the pods 30, 32, 40, 42, which may be separately purchased by or shipped to a user, may be easily attached to the core module 20 by the user without tools.

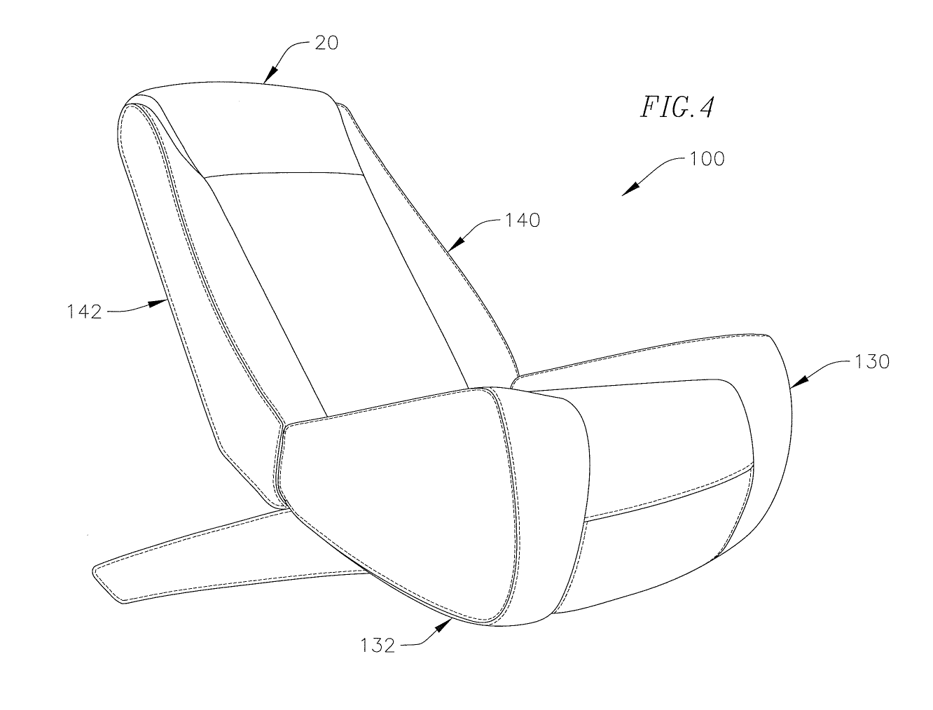

With reference to FIG. 4, a modular massage chair 100 according to another embodiment of the present invention is shown. The modular massage chair 100 is similar to the modular massage chair 10 described above and shown in FIG. 1. The modular massage chair 100 includes the same core module 20 as the modular massage chair 10 but, as shown in FIG. 4, includes pods 130, 132, 140, 142 corresponding to but differing in shape and/or size from the pods 30, 32, 40, and 42 of the modular massage chair 10. More specifically, the modular massage chair 100 includes the left seat pod 130 that is attachable to the left side of the seat portion 22, the right seat pod 132 that is attachable to the right side of the seat portion 22, the left backrest pod 140 that is attachable to the left side of the backrest portion 24, and the right backrest pod 142 that is attachable to the right side of the backrest portion 24. In one embodiment, each of the pods 130, 132, 140, 142 may differ in shape and/or size from the pods 30, 32, 40, and 42 of the modular massage chair 10. However, in another embodiment, one or more of the pods 130, 132, 140, 142 may differ in shape and/or size from the corresponding pods 30, 32, 40, and 42 while one or more of the pods 130, 132, 140, 142 has substantially a same shape and size as the corresponding pods 30, 32, 40, and 42.

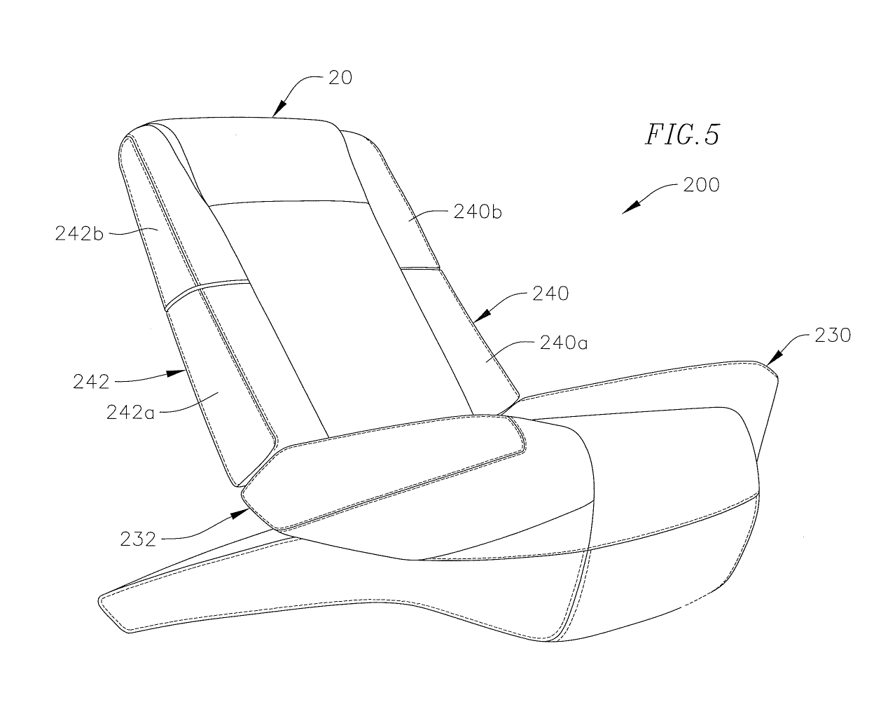

With reference to FIG. 5, a modular massage chair 200 according to another embodiment of the present invention is shown. The modular massage chair 200 is also similar to the modular massage chair 10 described above and shown in FIG. 1. The modular massage chair 200 includes the same core module 20 as the modular massage chair 10 and includes pods 230, 232, 240, 242 corresponding to but differing in shape and size from the pods 30, 32, 40, and 42 of the modular massage chair 10. That is, the left seat pod 230 is attachable to the left side of the seat portion 22, the right seat pod 232 is attachable to the right side of the seat portion 22, the left backrest pod 240 is attachable to the left side of the backrest portion 24, and the right backrest pod 242 is attachable to the right side of the backrest portion 24. In the modular massage chair 200, according to one embodiment, one or both of the backrest pods 240, 242 may be made up of two or more backrest pod portions. For example, as shown in FIG. 5 the left backrest pod 240 may include a lower left backrest pod 240a and an upper left backrest pod 240b, and the right backrest pod 242 may include a lower right backrest pod 242a and an upper right backrest pod 242b. That is, in one embodiment, rather than being formed as an integral unit, each of the lower left backrest pod 240a and the upper left backrest pod 240b, and similarly, each of the lower right backrest pod 242a and the upper right backrest pod 242b, are separately attachable to the core module 20. In another embodiment, one or both of the seat pods 230, 232 may be made up of two or more seat pod portions.

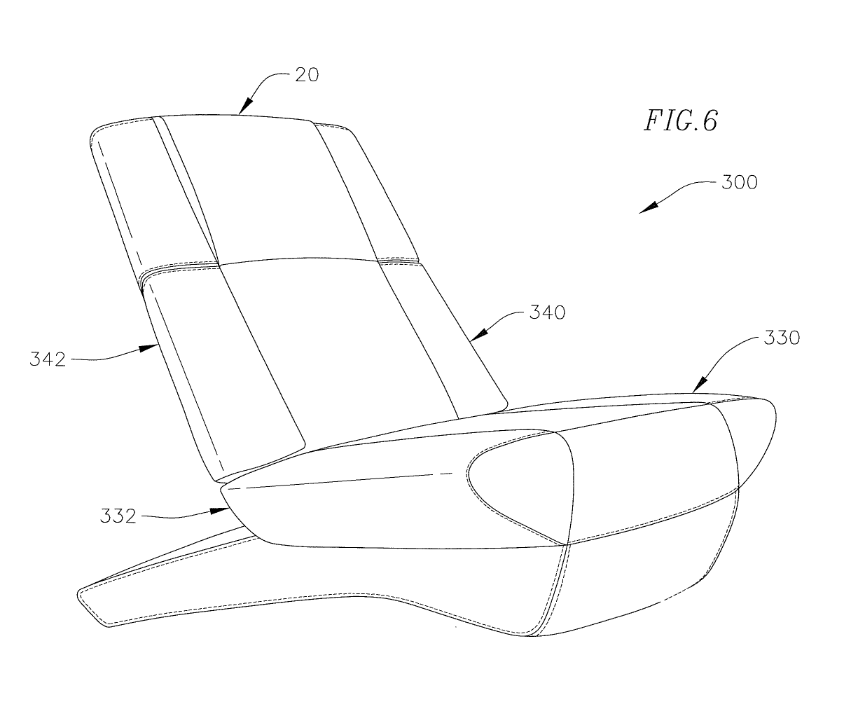

With reference to FIG. 6, a modular massage chair 300 according to another embodiment of the present invention is shown. The modular massage chair 300 includes the same core module 20 as the modular massage chair 10 and includes pods 330, 332, 340, 342 corresponding to but differing in shape and size from the pods 30, 32, 40, and 42 of the modular massage chair 10. As shown in FIG. 6, the left seat pod 330 is attachable to the left side of the seat portion 22, the right seat pod 332 is attachable to the right side of the seat portion 22, the left backrest pod 340 is attachable to the left side of the backrest portion 24, and the right backrest pod 342 is attachable to the right side of the backrest portion 24.

The present invention is not limited to the modular massage chairs 10, 100, 200, and 300 shown and described above. On the contrary, embodiments of a modular massage chair according to the present invention may include any suitable number of style pods attachable to the core module 20 and having any combination of shapes, sizes, materials, colors, connector patterns and/or other desired features.

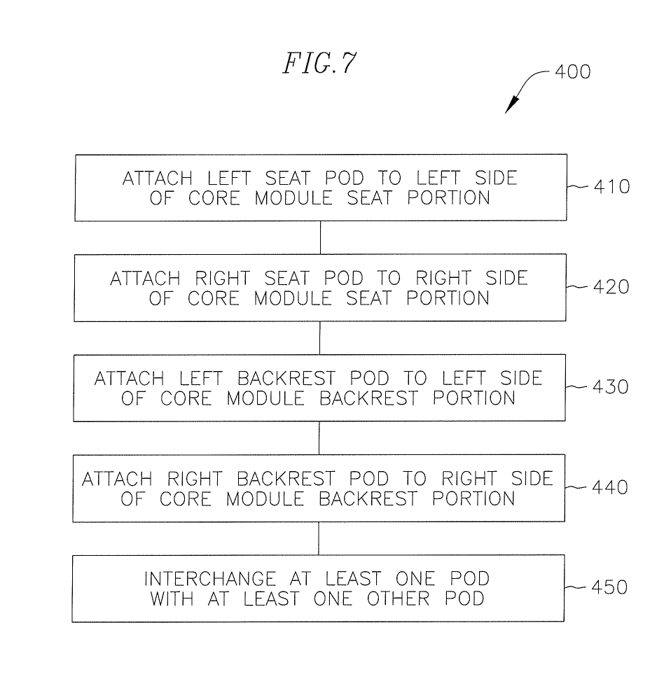

With reference to FIG. 7, a method 400 of assembling a modular massage chair is shown. While the method 400 is described herein with respect to the modular massage chair 10 described above and shown in FIG. 1, the method 400, or at least some of the tasks thereof, may be performed in assembling a modular massage chair according to other embodiments of the present invention, such as the modular massage chairs 100, 200, and 300 shown in FIGS. 4, 5, and 6, respectively.

In one embodiment, the method 400 includes a task 410 of attaching the left seat pod 30 to a left side of the seat portion 22 of the core module 20. In one embodiment, the pins 52 are aligned with the connectors 50 of each of the left seat pod 30 and the corresponding connectors 50 of the left side of the seat portion 22, and the left seat pod 30 is pushed toward the seat portion 22 such that the pins 52 are received inside the connectors 50 of each of the left seat pod 30 and the seat portion 22. A locking device of the connectors 50 and/or the pins 52, in one embodiment, produces an audible “pop” or “click” when the left seat pod 30 is attached to the seat portion 22.

Further, in one embodiment, the method 400 includes a task 420 of attaching the right seat pod 32 to a right side of the seat portion 22 of the core module 20. In one embodiment, similar to the task 410 described above, the pins 52 are aligned with the connectors 50 of each of the right seat pod 32 and the corresponding connectors 50 of the right side of the seat portion 22, and the right seat pod 32 is pushed toward the seat portion 22 such that the pins 52 are received inside the connectors 50 of each of the right seat pod 32 and the seat portion 22. A locking device of the connectors 50 and/or the pins 52, in one embodiment, produces an audible “pop” or “click” when the right seat pod 32 is attached to the seat portion 22.

Also, in one embodiment, the method 400 includes a task 430 of attaching the left backrest pod 40 to a left side of the backrest portion 24 of the core module 20. In one embodiment, similar to the task 410 described above, the pins 52 are aligned with the connectors 50 of each of the left backrest pod 40 and the corresponding connectors 50 of the left side of the backrest portion 24, and the left backrest pod 40 is pushed toward the backrest portion 24 such that the pins 52 are received inside the connectors 50 of each of the left backrest pod 40 and the backrest portion 24. A locking device of the connectors 50 and/or the pins 52, in one embodiment, produces an audible “pop” or “click” when the left backrest pod 40 is attached to the backrest portion 24.

Similarly, in one embodiment, the method 400 includes a task 440 of attaching the right backrest pod 42 to a right side of the backrest portion 24 of the core module 20. In one embodiment, similar to the task 430 described above, the pins 52 are aligned with the connectors 50 of each of the right backrest pod 42 and the corresponding connectors 50 of the right side of the backrest portion 24, and the right backrest pod 42 is pushed toward the backrest portion 24 such that the pins 52 are received inside the connectors 50 of each of the right backrest pod 42 and the backrest portion 24. A locking device of the connectors 50 and/or the pins 52, in one embodiment, produces an audible “pop” or “click” when the right backrest pod 42 is attached to the backrest portion 24.

In one embodiment, the method 400 may further include a task 450 of interchanging one or more of the pods 30, 32, 40, 42 with one or more other pods, such as one or more of the pods shown in FIGS. 4, 5, and 6. In one embodiment, the pods may be interchanged prior to being attached to the core module 20. In another embodiment, the pods may be removably attached to the core module 20 and may be interchanged after being attached to the core module 20. Because the core module 20 may have a standardized configuration, including a pattern of locations of the connectors 50, various combinations of different style pods may be combined with the core module 20 to assemble a modular massage chair according to the present invention.

While in one embodiment, the method 400 of assembling a modular massage chair may include each of the tasks described above and shown in FIG. 7, in other embodiments of the present invention, in a method of assembling a modular massage chair, one or more of the tasks described above and shown in FIG. 7 may be absent and/or additional tasks may be performed. Further, in the method 400 of assembling a modular massage chair according to one embodiment, the tasks may be performed in the order depicted in FIG. 7. However, the present invention is not limited thereto and, in a method of assembling a modular massage chair according to other embodiments of the present invention, the tasks described above and shown in FIG. 7 may be performed in any other suitable sequence.

Although the drawings illustrate the invention as applied to a modular massage chair, it will be apparent that the novel aspects of the modular massage chair of the invention may also be applied to other applications, such as other chairs. Further, it will be apparent to those skilled in the art that a modular massage chair may incorporate or embody various combinations of the embodiments described above with respect to the shapes, sizes, and components of the modular massage chairs, as well as alternatives not described herein, without departing from the spirit and scope of the present invention.

The preceding description has been presented with reference to some exemplary embodiments of the invention. Persons skilled in the art and technology to which this invention pertains will appreciate that alterations and changes in the described structures and methods of assembly and operation can be practiced without meaningfully departing from the principles, spirit, and scope of this invention, as set forth in the following claims.

What is claimed is:

1. A modular massage chair comprising:
a core module comprising a core module seat portion and a core module backrest portion; and
at least one modular outer chair portion attachable to at least one side of the core module.

2. The modular massage chair of claim 1, wherein the at least one modular outer chair portion comprises:
a first outer seat portion attachable to the core module seat portion at a first side of the core module;
a second outer seat portion attachable to the core module seat portion at a second side of the core module opposite the first side;
a first outer backrest portion attachable to the core module backrest portion at the first side of the core module; and
a second outer backrest portion attachable to the core module backrest portion at the second side of the core module.

3. The modular massage chair of claim 1,
wherein the core module further comprises a plurality of first socket-type connectors, and the at least one modular outer chair portion comprises a plurality of second socket-type connectors, and
wherein the modular massage chair further comprises a plurality of pins, each of the pins being insertable into a first connector of the plurality of first connectors and a second connector of the plurality of second connectors for attaching the at least one modular outer chair portion to the at least one side of the core module.

4. The modular massage chair of claim 3, further comprising a locking device configured to lock the pin and the first and second connectors together.

5. The modular massage chair of claim 3, wherein at least one of the first and second connectors comprises a spiked end configured to pierce a cover material of at least one of the core module or the at least one modular outer chair portion.

6. The modular massage chair of claim 1, further comprising a hook-and-loop type fastener affixed to the core module and the at least one modular outer chair portion for attaching the at least one modular outer chair portion to the at least one side of the core module.

7. The modular massage chair of claim 1, wherein at least one of a material or a color of the at least one modular outer chair portion is different from a respective material or color of the core module.

8. The modular massage chair of claim 1, wherein the core module has a standardized configuration such that the at least one modular outer chair portion is interchangeable with at least one other modular outer chair portion.

9. The modular massage chair of claim 1, wherein the core module has a width of about 16 inches to about 18 inches.

10. A modular massage chair system comprising:
a core module comprising a seat portion and a backrest portion; and
a plurality of modular chair portions attachable to at least one side of the core module,
wherein modular chair portions of the plurality of modular chair portions are interchangeably attachable to the at least one side of the core module.

11. The modular massage chair system of claim 10, wherein at least one of a shape, a size, or a color of a modular chair portion of the interchangeably attachable modular chair portions is different from a respective shape, size, or color of another of the interchangeably attachable modular chair portions.

12. The modular massage chair system of claim 10, wherein the core module further comprises a plurality of first connectors, and the modular chair portions comprise a plurality of second connectors engageable with the first connectors for attaching the modular chair portions to the at least one side of the core module.

13. The modular massage chair system of claim 12, wherein the core module has a pattern of locations of the first connectors, and locations of second connectors of the plurality of second connectors of each of the interchangeably attachable modular chair portions correspond to locations of first connectors of the pattern of locations of the core module.

14. A method of assembling a modular massage chair, the method comprising:
providing a core module including a core module seat portion and a core module backrest portion; and
attaching at least one modular outer chair portion to the core module.

15. The method of claim 14, wherein attaching the at least one modular outer chair portion to the core module comprises:
attaching a first outer seat portion of the at least one modular outer chair portion to the core module seat portion at a first side of the core module;
attaching a second outer seat portion of the at least one modular outer chair portion to the core module seat portion at a second side of the core module opposite the first side;
attaching a first outer backrest portion of the at least one modular outer chair portion to the core module backrest portion at the first side of the core module; and
attaching a second outer backrest portion of the at least one modular outer chair portion to the core module backrest portion at the second side of the core module.

16. The method of claim 14, wherein attaching the at least one modular outer chair portion to the core module comprises inserting a pin into a socket-type connector of each of the core module and the at least one modular outer chair portion.

17. The method of claim 14, wherein attaching the at least one modular outer chair portion to the core module comprises attaching a loop portion of a hook-and-loop type fastener that is affixed to at least one of the core module and the at least one modular outer chair portion to a hook portion of the hook-and-loop type fastener that is affixed to at least the other of the core module and the at least one modular outer chair portion.

18. The method of claim 14, further comprising interchanging the at least one modular outer chair portion with at least one other modular outer chair portion.
